(19) United States
(12) Patent Application Publication
(10) Pub. No.: US 2014/0174880 A1
(43) Pub. Date: Jun. 26, 2014

(54) ANTI-FISHING DEVICE FOR A COIN CHUTE

(71) Applicant: J.J. MACKAY CANADA LIMITED, New Glasgow (CA)

(72) Inventors: George Allan MacKay, New Glasgow (CA); Michael Glenn Fievet, New Glasgow (CA)

(73) Assignee: J.J. MACKAY CANADA LIMITED, New Glasgow (CA)

(21) Appl. No.: 14/094,382

(22) Filed: Dec. 2, 2013

(30) Foreign Application Priority Data
Dec. 20, 2012 (CA) 2799870
Oct. 25, 2013 (CA) 2831034

(51) Int. Cl. G07F 1/04; G07F 17/24

(52) U.S. Cl. CPC G07F 1/043; G07F 17/248
USPC 194/203

(57) ABSTRACT

An anti-fishing device is located in close proximity to a location where coins are inserted into a parking meter, or other vending or metering machine. The anti-fishing device does not require any moving parts and presents an obstacle in the coin path that impedes the withdrawal of inserted coins from a coin chute. The anti-fishing device may comprise one or more fingers that extend into a coin channel. The fingers of the anti-fishing device may extend backwards into the coin channel. The anti-fishing device may be made from a single piece of material and may be incorporated into new coin chutes as well being retrofit into existing coin chutes, parking meters, or other vending or metering machines.

### TECHNICAL FIELD

The current application relates to coin chutes, and in particular to coin chutes that impede the fishing of coins.

### BACKGROUND

Devices and machines that accept coins for payment, such as parking meters and vending machines, are typically unattended and located in public areas. As such, they are sometimes the subject of vandalism, and theft (of, for example, either the parking meter itself or the coins used to pay for parking). With respect to parking meters, they generally include a coin chute into which coins are inserted. As the coin passes through the coin chute it may pass an arrangement of one or more sensors, typically inductive coils that can discriminate the value of the coin. Once the coin passes through the discrimination sensors in the meter it travels from the upper portion of the parking meter housing and enters into a coin can located in a lower vault, which is secured against theft by way of a hardened housing.

Some coin chutes have an anti-pull back device that prevents or impedes coins from being pulled back and out of the coin chute. For example, pulling a coin back and out of the coin chute may be done by using a string fastened to the coin, and pulling the coin out of the chute after the coin has fallen down the coin chute and been detected by the discrimination sensors. By employing an anti-pull back device, the same coin is prevented from being pulled back up the chute. This in turn prevents the same coin from passing through the discrimination sensors multiple times in order to receive credit for paid parking time without having deposited the required amount of coins. These anti-pull back devices can be found both in the meter, as well as at the entrance to the coin can located in the lower vault area.

In one example, the anti-pull back device comprises a hinged lever located near the coin slot where coins are inserted. When in a resting position, the hinged lever is rotated downward into coin channel under the force of gravity. When a coin is inserted into the coin slot, the hinged lever rotates up and out of the way allowing the coin to be fully inserted into the coin channel. Locating the anti-pull back device near the coin insertion point allows the anti-pull back device to be overcome by moving the lever, which is easily accessible through the coin insertion point, in an upward direction and out of the coin channel, thereby allowing a coin to be pulled back out of the meter.

As an alternative to the example of locating the anti-pull back device near the coin insertion point, the anti-pull back device may be located further down the coin channel. With the anti-pull back device located further down the coin channel it may be more difficult to defeat the anti-pull back device by simply displacing it out of the coin channel. Such anti-pull back devices may comprise a number of hinged levers that extend into the coin channel. These levers may be located in close proximity to the sensors for discriminating the denominations of the coins. The levers are free to rotate out of the coin channel under the downward force of an inserted coin. However, these levers are prevented from rotating out of the coin channel under an upward force, for example by pulling up on a coin.

The anti-pull back devices described above rely on a mechanical component that moves out of the path of a coin when inserted, but moves back to block the coin path to impede pulling back the coin. Software-based anti-pull back techniques that do not rely on moving mechanical devices in the coin path are also possible. Software-based approaches may utilize the coin discrimination sensors to detect if a coin has been pulled back through the discriminators. If a pull back is detected, the coin would not be registered, and so no time purchased. While the software-based anti-pull back techniques may be effective for preventing additional time from being purchased through pulling back a single coin, they require that the discrimination sensors be powered for a longer period of time (e.g., up to one minute or more) to detect the possible pull back. This additional power consumption may be undesirable in battery powered parking meters.

While the anti-pull back devices can prevent or impede pulling back the same coin in order to be counted numerous times, they may not prevent or impede all types of schemes to defraud a parking authority, or paying customer, of money. For example, a vandal or thief may force a foreign object into the coin chute in order to cause a jam in the coin channel, such as a jam just above the anti-pull back device that is located further down the coin channel. The foreign object may be non-metallic so that it may not be detected by sensors in the coin chute, which results in the parking meter remaining in service. When an unsuspecting customer attempts to make a payment, the inserted coins will remain in the coin chute instead of passing into the coin vault. The thief or vandal may then attempt to fish out the inserted coins that are still in the coin chute.

An improved, additional or alternative coin chute that can impede the fishing of inserted coins from the coin chute is desirable.

### SUMMARY

In accordance with the present disclosure there is provided a parking meter comprising parking meter components for metering an amount of time purchased. The parking meter also comprises a coin chute for receiving coins for purchasing the amount of time. The coin chute comprises a channel defined by a first sidewall and a second sidewall opposite the first sidewall, the channel having a first location where coins inserted into the parking meter enter the channel, and a second location where the coins exit the channel. The parking meter also comprises an anti-fishing device located in close proximity to the first location of the channel.

In accordance with the present disclosure there is further provided a coin chute for receiving coins in a vending or metering machine. The coin chute comprises a channel defined by a first sidewall and a second sidewall opposite the first sidewall, the channel having a first location where coins enter the channel and a second location where coins exit the channel, and an anti-fishing device located in close proximity to the first location of the channel.

In accordance with the present disclosure there is further provided an anti-fishing device for a coin chute comprising a body defining a coin opening sized to receive a coin, and a first anti-fishing finger connected to a side of the coin opening and projecting away from the body at an angle to a normal of the body when in use.

### BRIEF DESCRIPTION OF THE DRAWINGS

Further features and advantages of the present disclosure will become apparent from the following detailed description, taken in combination with the appended drawings, in which:

FIG. 1 depicts a parking meter which may incorporate an anti-fishing device in accordance the present disclosure;

FIG. 2 depicts a disassembled view of the parking meter of FIG. 1;

FIG. 3 depicts a rear perspective view of a coin chute;

FIG. 4 depicts a rear perspective view of components of the coin chute of FIG. 3;

FIG. 5 depicts a front perspective view of components of the coin chute of FIG. 3;

FIG. 6A depicts a front view block diagram of a coin chute;

FIG. 6B depicts a side view block diagram of a coin chute;

FIG. 6C depicts a top view block diagram of a coin chute;

FIGS. 7A and 7B depict anti-fishing devices;

FIG. 8 depicts a perspective view of an anti-fishing device; and

FIGS. 9A and 9B depict front and back perspective views of an anti-fishing device.

### DETAILED DESCRIPTION

A parking meter that incorporates an anti-fishing device may impede withdrawal of coins from a coin chute. As described further herein, an anti-fishing device may be incorporated into a coin chute during manufacture, or may be retrofit into existing coin chutes. The anti-fishing device may be incorporated into a coin chute in addition to an anti-pull back device that prevents or impedes a coin from being pulled past a coin discriminator a plurality of times. The anti-fishing device provides an obstacle in a coin channel that impedes fishing coins from the coin channel. As described further below, the anti-fishing device does not require any moving parts.

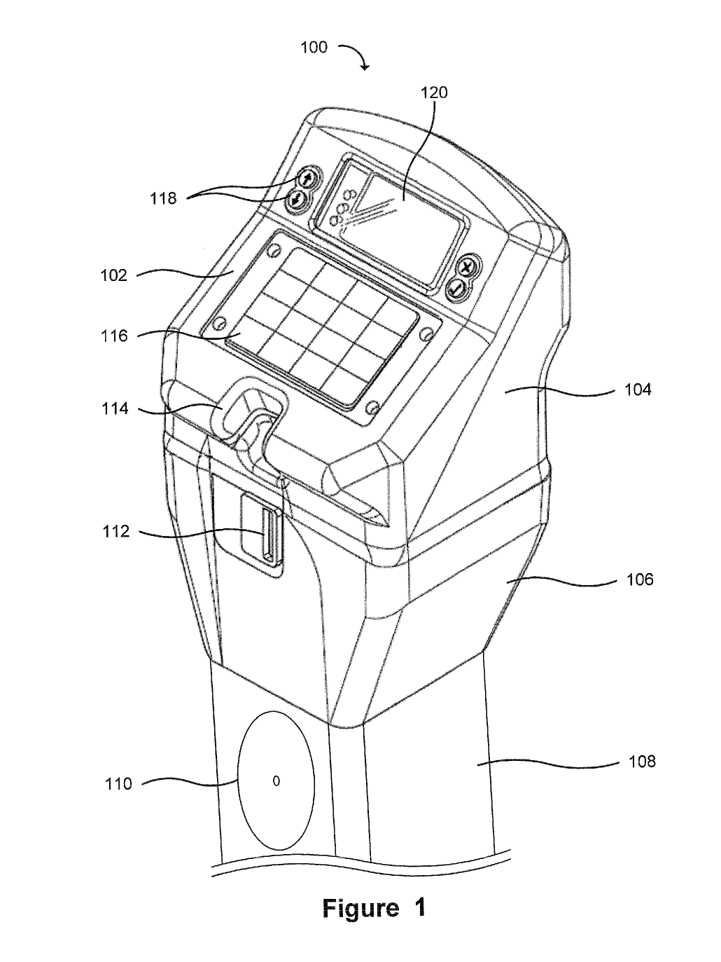

FIG. 1 depicts a parking meter which may incorporate an anti-fishing device in accordance with the present disclosure. The parking meter 100 is a single space parking meter. Although parking meter 100 is referred to as a single space parking meter, it may actually meter parking time for two or more parking spaces. Single space parking meters comprise a removable parking meter mechanism 102 which is housed within a housing for the upper portion of the parking meter. As depicted in FIG. 1, the housing may comprise a back housing 104 and a lower housing 106. The lower housing 106 may be attached to a coin vault 108 that may be typically installed on a pole near a parking meter location associated with the meter 100. The coin vault 108 may include a coin canister and a vault door no that can be locked to prevent unauthorized access to coins being stored in the vault 108. The coins may be inserted into the parking meter through a coin slot 112 in the housing of the parking meter mechanism 102. The coin enters a coin channel of a coin chute where a coin discrimination sensor can determine the denomination of the inserted coin.

The removable parking meter mechanism 102 may comprise alternative payment means such as a card payment means 114. The parking meter mechanism 102 may include a solar panel 116 for charging a battery pack of the mechanism. The parking meter mechanism 102 may also include one or more input controls 118 for controlling operation of the meter mechanism as well as a display 120 for displaying an amount of parking time purchased.

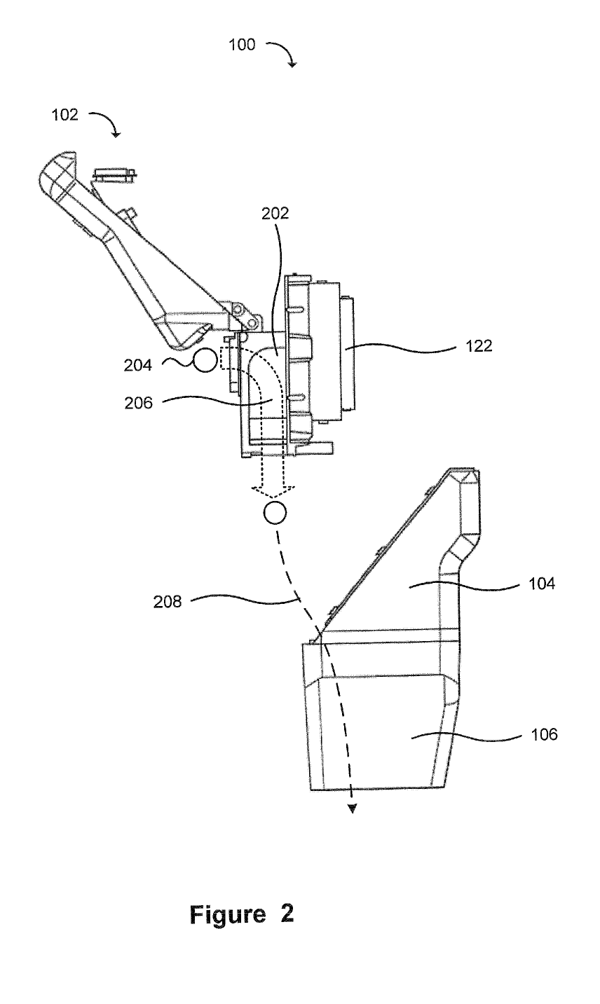

FIG. 2 depicts a disassembled view of the parking meter 100 of FIG. 1. As depicted, the removable parking meter mechanism 102 can be removed from the back housing 104 and the lower housing 106. The coin vault is not depicted in FIG. 2; however, it would be attached to the bottom of the lower housing 106. The removable parking meter mechanism 102 includes components for metering the parking spot, or spots. The metering components may include a display and control components as well as electronics for controlling the operation of the parking meter. The removable parking meter mechanism may include a battery pack 122 for powering the components of the removable parking meter mechanism 102. The removable parking meter mechanism 102 further comprises a coin chute 202 that includes a coin channel that allows a coin inserted into the coin slot of the parking meter to pass through a sensor, or sensors, that can discriminate the denomination of the inserted coin. A coin 204 that is inserted into the coin slot of the parking meter enters the coin channel and passes through the coin chute 202, as depicted by arrow 206. When the parking meter is assembled, as shown in FIG. 1, the coin 204 passes through the coin channel in the direction of arrow 206 and into the coin vault, as depicted by dashed line 208.

Although not depicted, multi-space parking meters often have a number of the same components as the single space parking meter 100 of FIGS. 1 and 2, including housing, display, coin chute, vault, a card payment means, solar panel, and battery pack components. Multi-space parking meters differ from single space parking meters in that the multi-space meters are typically larger devices capable of managing the parking payment and control for possibly as many as hundreds of parking spaces. Notwithstanding any differences, multi-space parking meters may incorporate an anti-fishing device in accordance with the present disclosure.

A thief wishing to defraud a parking authority or paying customer may place a coin attached to a string into the coin chute. Once the coin passes the coin discriminator, the thief can pull the coin up past or above the coin discriminator, and then allow the coin to be lowered and pass through the discriminator again. In order to prevent this type of theft, the coin chute 202 may include an anti-pull back device that prevents a coin 204 from being pulled up the coin chute once it has passed the coin discriminator. In addition, if the coin travels into the coin canister in the vault area, the coin canister may also have built-in anti-pull back levers that will trap the coin inside the coin canister. The anti-pull back device may comprise a number of moveable fingers that are pivoted out of the path of the coin by the downward force of the coin, but are prevented from pivoting out of the coin path when pulled upwards. Although the anti-pull back device can prevent a single coin from being counted a plurality of times, other types of fraud are possible. For example, a thief or vandal may insert an object into the coin channel to block the channel. When a user inserts a coin, it will enter the coin channel; however, it will not pass the anti-pull back device due to the foreign object jam. The inserted coin or coins will remain in the coin channel, and once the user leaves the parking meter, the thief may approach the meter and fish the inserted coins out of the coin channel. The addition of optical sensors incorporated into the coin chute could provide additional detection of jams within the coin channel and place the parking meter into a non-functioning state; however, retrofitting or adding the required optical sensors to the coin chute may not be possible or practical, and may require replacement of the entire coin chute assembly.

In order to discourage fishing types of theft, an anti-fishing device may be incorporated into the coin chute, or may be retrofit into existing parking meters. The anti-fishing device is placed in close proximity to the insertion point of the coin chute. As described further herein, the anti-fishing device may comprise one or more fingers that extend from a side of the coin channel into the coin channel. The fingers allow a coin to be inserted into the coin channel; however, if the coin is attempted to be withdrawn from the coin channel, the fingers may block the coin from being withdrawn. The anti-fishing device may be made from a resilient or semi-resilient material allowing the fingers to deflect; however, the anti-fishing device does not include moveable parts. As such, even if the fingers are displaced by a thief, the fingers remain in the coin channel and would still present at least somewhat of an obstacle to fishing out coins.

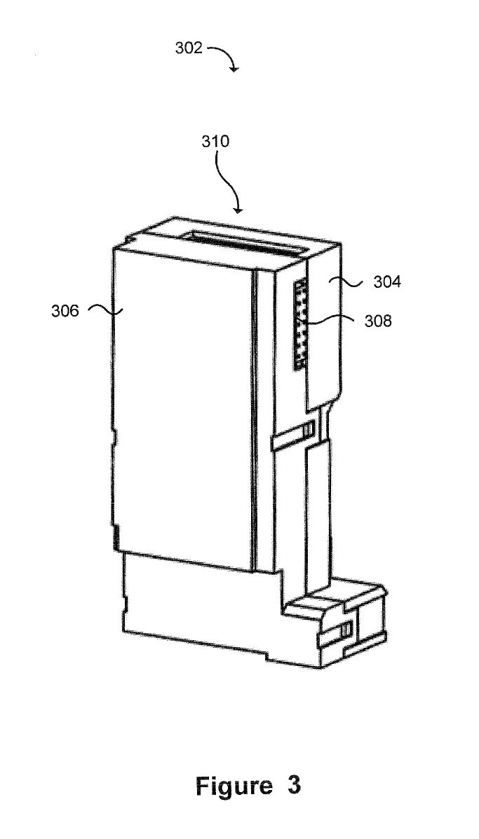

FIG. 3 depicts a rear perspective view of an assembled coin chute. The assembled coin chute 302 depicted in FIG. 3 may be used as the coin chute 202 of FIG. 2. The assembled coin chute 302 is modular and can be removed from the parking meter and replaced if necessary. The assembled coin chute 302 may comprise a removable shell comprised of two halves 304, 306 that can be snapped together around an internal coin chute 308 to provide protection for its components. The shell may include an opening in the top of the assembled coin chute 310 that can be used to clear jams from the coin channel. The assembled coin chute 302 includes an opening on the front, which is not visible in FIG. 3, that allows a coin to be inserted into the coin channel. The coin insertion opening in the assembled coin chute aligns with the coin slot in the parking meter when the parking meter is assembled.

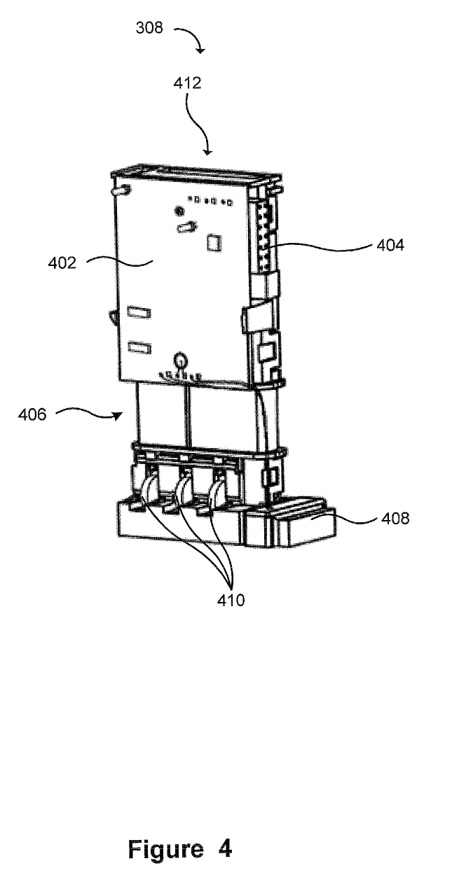

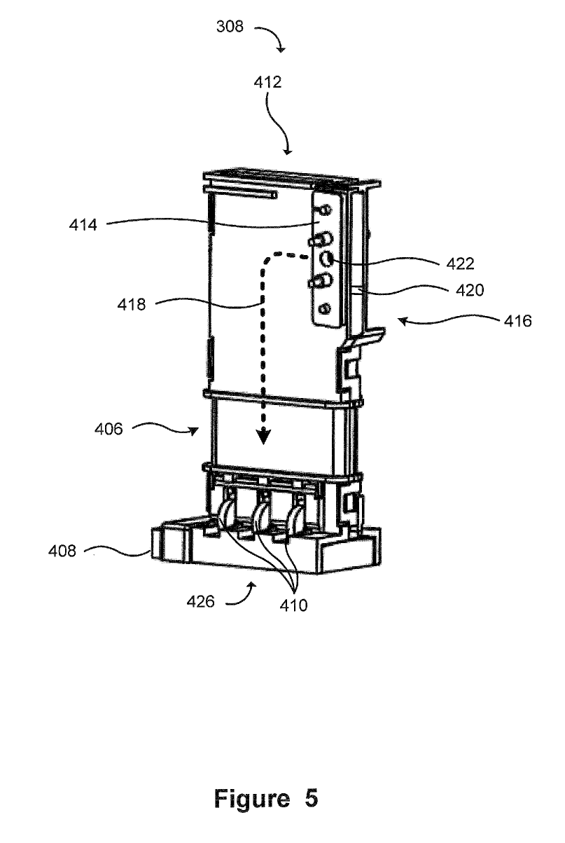

FIG. 4 depicts a rear perspective view of the internal coin chute 308 of FIG. 3. The internal coin chute 308 may be housed in the shell depicted in FIG. 3. The internal coin chute 308 may include electronics 402 and a connection interface 404 for coupling the internal coin chute to the electronics of the parking meter. The electronics 402 of the internal coin chute 308 may include a controller for controlling the discrimination functionality of the coin chute; however, this controller functionality may also be located on the main controller board of the parking meter. The coin discrimination may be provided by a plurality of inductive coils. A first inductive coil can be located around a middle portion 406 of the internal coin chute 308. A second inductive coil can be located at a lower portion 408 of the internal coin chute 308. The denomination of a coin can be determined once it has passed through both the inductive coils. An anti-pull back device comprising a number of moveable levers 410 can be located between the two inductive coils in order to prevent a coin from passing though the two inductive coils more than once. A top opening 412 allows the coin channel to be inspected for potential jams, and allows clearing of jams. As described further with regard to the front perspective view of FIG. 5, an anti-fishing device can be incorporated into the coin chute.

FIG. 5 depicts a front perspective view of the internal coin chute 308 of FIG. 3. It is noted that some of the components, such as electronics and wires, are not depicted in FIG. 5 for clarity of the Figure. The internal coin chute 308 has a middle portion 406 around which an inductive coil can be wrapped to provide a sensor for coin discrimination. A second coin discrimination coil can be located at the lower portion 408 of the internal coin chute 308. An anti-pull back device comprising a number of moveable levers 410 allows a coin to pass down the coin channel, as depicted by coin path arrow 418, while preventing the coin from being pulled back up the coin channel past the coin discriminator. The coin channel passes through the center of the internal coin chute 308 and has three openings. A top opening 412 allows the coin channel to be inspected and jams cleared. A front opening 416 allows coins to be inserted into the coin channel from via the coin slot in the parking meter. A bottom opening 426 allows the inserted coins to pass out of the coin channel and into the coin vault. The internal coin chute 308 may further comprise inductive coils 414 on each side of the coin chute near the front opening 416. The inductive coils 414 may be aligned with each other and used to detect when a coin is inserted into the coin channel, and so wake up the other components, such as the coin discrimination functionality, of the coin chute. A pair of IR optics 422 may be incorporated into the internal coin chute near the front opening 416. The IR optics can detect non-metallic jams in the coin chute. An anti-fishing device 420 may also be located in close proximity to the front opening 416. The anti-fishing device 420 may comprise one or more fingers that extend from the sides of the internal coin chute 308 into the coin channel. The fingers may partially extend backwards into the coin channel and allow a coin to be inserted into the coin channel; however, the backwardly extending fingers make it more difficult to fish a coin from the coin channel. While the anti-pull back device prevents a thief from pulling a single coin on a string past the discriminator numerous times, the anti-fishing device impedes coins, which may not have passed the discriminator or the anti-pull back device and are simply resting in the coin channel, from being withdrawn from the coin channel. The anti-fishing device 420 may help to reduce vandalism, such as intentionally jamming or blocking the coin chute with a foreign object to prevent inserted coins from passing the anti-pull back device, since it makes the fishing of coins more difficult and so not worth the thief s time and effort.

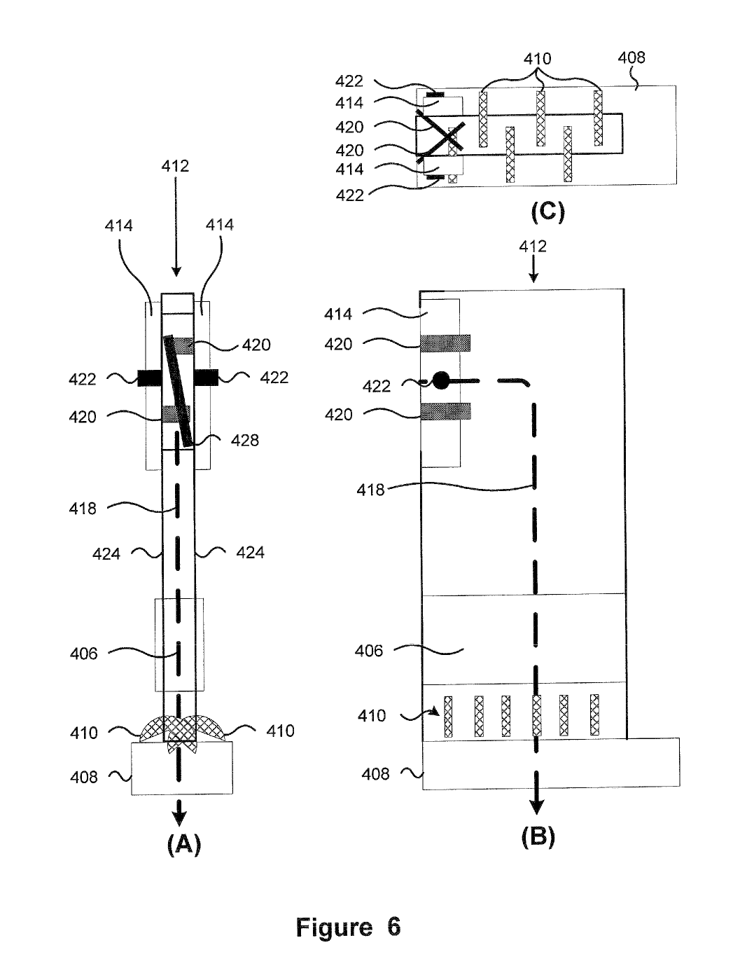

FIGS. 6A, 6B, and 6C depict front, side and top view block diagrams of the internal coin chute, respectively. The block diagrams depict the various components described above, including the portions comprising the first and second coin discrimination inductors 406, 408, the coin detection coils 414, the IR optics 422 and the anti-pull back device comprising a number of levers 410 located on opposite sides of the coin channel. Each lever can be rotated out of the coin path by a falling coin. However, the levers are physically prevented from rotating out of the coin path by a coin being pulled upwards. The coin path 418 and the inspection opening 412 are also depicted in the Figures. The coin channel that the coin path follows can be provided by opposite sidewalls 424 of the internal coin chute.

The anti-fishing device 420, as depicted, comprises two fingers located in close proximity to the coin insertion opening 416 of the internal coin chute. The two fingers of the anti-fishing device 420 extend into the coin path 418 from opposite sides of the coin channel. The fingers are positioned such that they do not pinch or stop the coin as it enters; however, the anti-fishing device may cause a tilting of a coin 428 as it enters the coin channel at the coin insertion opening 416. The anti-fishing device may be formed of a plastic material that does not interfere with the coin detection coils 414 located at the coin insertion opening 416. Further, the anti-fishing device 420 may be located so that it does not interfere with the IR optics 422. As can be seen from FIGS. 6A, 6B and 6C the two fingers of the anti-fishing device 420 provide an obstruction in the coin path, but do not prevent the coin from being pushed into the coin channel. However, a coin being fished out of the coin channel will need to be rocked or angled slightly in order to not be stopped by the tips of the inward pointing fingers of the anti-fishing device 420. Although the anti-fishing device 420 may not completely prevent the fishing of coins out of the coin channel, it does present an additional obstacle that impedes the ease with which a coin can be successfully fished from the coin channel. The anti-fishing device 420 may be formed as an integral part of the internal coin chute. Alternatively, the anti-fishing device may be formed as a separate insert. When formed as a separate insert, the anti-fishing device may be retrofitted into or onto existing coin chutes in order to provide an anti-fishing device for existing parking meters.

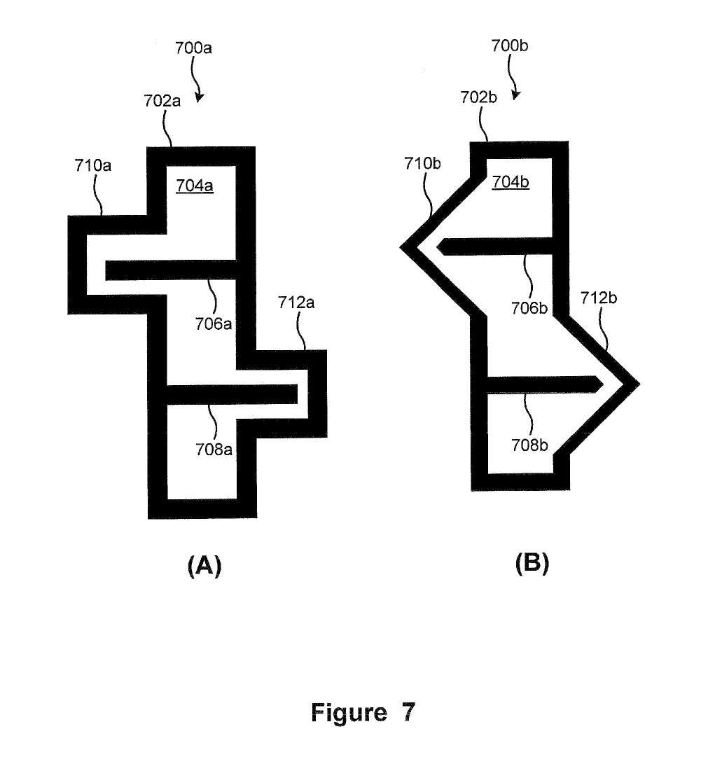

FIGS. 7A and 7B depict anti-fishing devices. The anti-fishing devices 700a, 700b are similar and will be described together. Each of the anti-fishing devices 700a, 700b may be made from a flat sheet of resilient or semi-resilient material. The resilient, or semi-resilient, material allows some flexibility in the anti-fishing device. The anti-fishing devices 700a, 700b each comprise a respective body 702a, 702b. The bodies 702a, 702b surround an interior opening 704a, 704b through which coins can be inserted. First fingers 706a, 706b extend from a first side of the body. Second fingers 708a, 708b extend from an opposite side of the body. In order to provide sufficiently long fingers to provide an obstacle to coin fishing, the fingers 706a, 706b, 708a, 708b may extend past a perimeter of the interior opening of the body 702a, 702b. In order to allow the anti-fishing device to be formed from a single piece of flat material, cutout tabs 710a, 710b, 712a, 712b can extend outward from the perimeter of the interior opening of the body in order to provide sufficient material to cutout the fingers 706a, 706b, 708a, 708b. Once cutout, the anti-fishing devices 700a, 700b may be installed into or onto coin chutes by bending the fingers 706a, 706b, 708a, 708b inward and placing the anti-fishing device in close proximity to the coin insertion opening of the coin chute. The anti-fishing device may be secured within an outer shell of the coin chute, to the exterior of the coin chute, or to the coin slot of the parking meter. Regardless of how the anti-fishing device is incorporated into the parking meter, it is located in close proximity to the coin insertion opening to impede coins from being fished out of the coin channel. Further, since the anti-fishing device is located in close proximity to the coin insertion opening, blocking or jamming it would also impede any coins from being inserted into the meter and so would impede the coins from resting or accumulating in the coin channel as with a blocked anti-pull back mechanism.

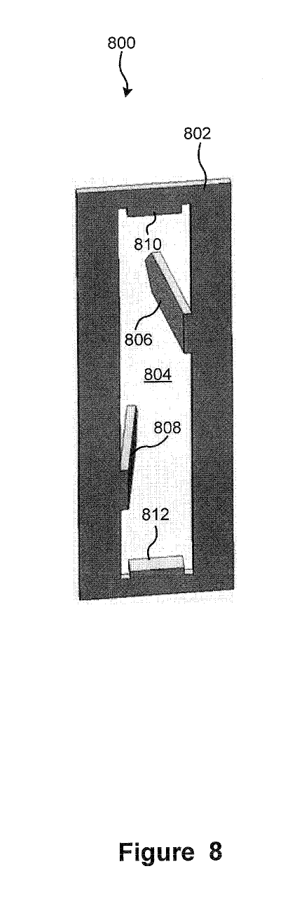

FIG. 8 depicts a perspective view of a further anti-fishing device. The anti-fishing device 800 is similar to the anti-fishing devices 700a, 700b; however, it is made as a molded or cast piece. The anti-fishing device 800 comprises a body 802 surrounding a coin opening 804. The anti-fishing device 800 includes two fingers 806, 808 that extend backwards into the coin channel when the anti-fishing device 800 is placed in the parking meter. The anti-fishing device 800 may have upper and lower locating tabs 810, 812 that may help to position the anti-fishing device within the coin channel. The anti-fishing device 800 may be located in close proximity to the coin insertion opening. For example, the anti-fishing device 800 may be placed at the front of the coin channel.

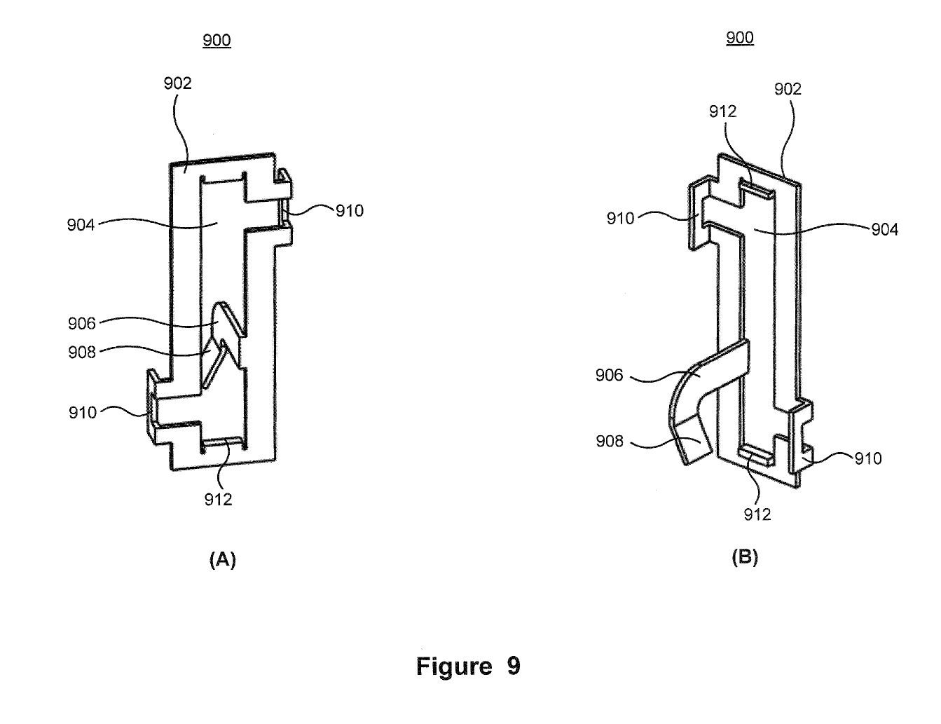

FIG. 9A depicts a front perspective view of a further anti-fishing device 900. FIG. 9B depicts a rear perspective view of the anti-fishing device 900. The depicted anti-fishing device 900 may be used in place of the anti-fishing devices described above. The anti-fishing devices described above have two fingers extending back into the coin channel. In contrast to the above, the anti-fishing device 900 has a single finger extending back into the coin channel.

The anti-fishing device 900 comprises a body 902 surrounding a coin opening 904. A single finger extends back into the coin channel. The single finger comprises a backward extending portion 906 that extends into the coin channel. The single finger extends from one side of the coin channel. The single finger comprises a downward projecting portion 908 that extends from the backwards extending portion 906 downward and across the coin channel. That is, a portion of the finger extends downward from one side of the coin channel toward the other side of the coin channel. The body 902 of the anti-fishing device 900 may comprise one or more alignment tabs 910, 912 that orient the anti-fishing device within the coin channel. As depicted, there are left and right tabs 910 as well as top and bottom tabs 912 that facilitate arrangement of the anti-fishing device within the coin channel 904. As depicted the single finger that extends backwards and from one side of the coin channel to the other allows coins to be inserted without interfering with the inserted coin. The finger extending backwards and downwards towards the opposite side interferes with removing inserted coins, thereby providing an impediment to the retrieval of coins inserted into the coin channel.

The anti-fishing device may be located in close proximity to the coin-insertion location. Accordingly, any blockages of the anti-fishing device will be visible from the coin-insertion location.

The above has described anti-fishing devices having one or two fingers extending backwards into the coin channel. It is possible for an anti-fishing device to include one finger, two fingers or more. Further, the above has described the two fingers as causing an inserted coin to tip to a side; however, if the anti-fishing device is made of a material having a flexibility that allows the fingers to bend slightly when a coin is inserted, then the anti-fishing device may not require an inserted coin to tip when inserted. In such a case, the fingers can bend slightly inwards into the coin channel. Due to the fingers being longer than the width of the coin channel and either the surrounding coin chute housing or parking meter coin slot housing/opening, the fingers may not bend outwards (or forwards) out of the coin channel and so can still provide an obstacle to impede fishing of coins from the coin channel. Additionally, although the above has described the anti-fishing device as having two fingers located on opposite sides of the coin channel, it is contemplated that the fingers could all be located on the same side of the coin channel and still impede coin fishing.

The anti-fishing device is located in close proximity to the coin insertion opening of the coin chute, or the coin slot in the housing. If a thief or vandal attempts to block the anti-fishing device with a foreign object, a user of the parking meter would be able to see the jam and would likely be discouraged or impeded from inserting coins. As such, the scheme for fishing coins out of a coin chute of the vandal or thief may be thwarted. Alternatively, if the anti-fishing device is not blocked or jammed, it may make the fishing of inserted coins more difficult and as such may discourage further fishing attempts by the thief or vandal.

The above has described an anti-fishing device with regard to its use with a particular coin chute embodiment. It is contemplated that the anti-fishing device can be easily incorporated into other coin chutes. For example, regardless of the particular arrangement of coin discrimination sensors, anti-pull back devices and coin channels, the anti-fishing device described herein can be placed in close proximity to the coin insertion opening of a coin chute and provide an obstacle to fishing coins out of the coin chute. Further, although described with particular reference to parking meters, it is contemplated that the anti-fishing device for coin chutes can be used with other coin accepting devices which are susceptible to theft by way of fishing.

An anti-fishing device for use with a coin chute, a coin chute incorporating an anti-fishing device, as well as a parking meter incorporating an anti-fishing device coin chute have been described by way of examples. It will be appreciated that components of one example may be incorporated into another example. Furthermore, variations and modifications not described herein will be apparent to one of ordinary skill in the art having regard to the description herein.

What is claimed is:

1. A parking meter comprising:
parking meter components for metering an amount of time purchased;
a coin chute for receiving coins for purchasing the amount of time, the coin chute comprising a channel defined by a first sidewall and a second sidewall opposite the first sidewall, the channel having a first location where coins inserted into the parking meter enter the channel, and a second location where the coins exit the channel; and
an anti-fishing device located in close proximity to the first location of the channel.

2. The parking meter of claim 1, wherein the anti-fishing device allows the insertion of coins into the channel and impedes the retrieval of coins inserted into the channel through the first location of the channel.

3. The parking meter of claim 1, wherein the anti-fishing device comprises at least one finger extending away from the first sidewall of the channel towards the second sidewall.

4. The parking meter of claim 1, wherein the anti-fishing device comprises:
a first finger extending away from the first sidewall of the channel towards the second sidewall; and
a second finger extending away from the second sidewall of the channel towards the first sidewall.

5. The parking meter of claim 4, wherein at least one of the first and second fingers extend inwards into the channel.

6. The parking meter of claim 1, wherein the anti-fishing device comprises a single finger comprising a first section that extends backwards into the coin channel from a first side of the coin channel and a second section attached to the first section that extends downward and across the coin channel from the first side of the coin channel to the second side of the coin channel.

7. The parking meter of claim 1, wherein the anti-fishing device is made from a single piece of resilient or semi-resilient material.

8. The parking meter of claim 1, wherein the coin chute comprises an exterior shell and wherein the anti-fishing device is located within the exterior shell.

9. The parking meter of claim 1, wherein the coin chute comprises an exterior shell and wherein the anti-fishing device is located on an exterior of the exterior shell.

10. The parking meter of claim 1, wherein the anti-fishing device is located on an internal surface of a housing of the parking meter at a coin slot of the parking meter.

11. The parking meter of claim 1, wherein the coin chute further comprises:
a coin discriminator for determining a denomination of a coin inserted into the channel; and
an anti-pull back device to prevent coins that have passed the coin discriminator from being withdrawn past the coin discriminator.

12. A coin chute for receiving coins in a vending or metering machine, the coin chute comprising:
a channel defined by a first sidewall and a second sidewall opposite the first sidewall, the channel having a first location where coins enter the channel and a second location where coins exit the channel; and
an anti-fishing device located in close proximity to the first location of the channel.

13. The coin chute of claim 12, wherein the anti-fishing device allows the insertion of coins into the channel and impedes the retrieval of coins inserted into the channel through the first location of the channel.

14. The coin chute of claim 12, wherein the anti-fishing device comprises at least one finger extending away from the first sidewall of the channel towards the second sidewall.

15. The coin chute of claim 12, wherein the anti-fishing device comprises:
a first finger extending away from the first sidewall of the channel towards the second sidewall; and
a second finger extending away from the second sidewall of the channel towards the first sidewall.

16. The coin chute of claim 12, wherein the anti-fishing device comprises a single finger comprising a first section that extends backwards into the coin channel from a first side of the coin channel and a second section attached to the first section that extends downward and across the coin channel from the first side of the coin channel to the second side of the coin channel.

17. The coin chute of claim 12, wherein at least one of the first and second fingers extend inwards into the channel.

18. The coin chute of claim 12, wherein the anti-fishing device is made from a single piece of resilient material or semi-resilient material.

19. The coin chute of claim 12, further comprising an exterior shell and wherein the anti-fishing device is located within the exterior shell.

20. The coin chute of claim 12, further comprising an exterior shell and wherein the anti-fishing device is located on an exterior of the exterior shell.

21. The coin chute of claim 12, further comprising:
a coin discriminator for determining a denomination of a coin inserted into the channel; and
an anti-pull back device to prevent coins that have passed the coin discriminator from being withdrawn past the coin discriminator.

22. An anti-fishing device for a coin chute comprising:
a body defining a coin opening sized to receive a coin; and
a first anti-fishing finger connected to a side of the coin opening and projecting away from the body at an angle to a normal of the body when in use.

23. The anti-fishing device of claim 22, further comprising a second anti-fishing finger connected to a side of the coin opening and projecting away from the body at an angle to a normal of the body.

24. The anti-fishing device of claim 23, wherein the first anti-fishing finger is connected to a first side of the coin opening and the second anti-fishing finger is connected to a second side of the coin opening opposite the first side.

25. The anti-fishing device of claim 22, wherein the first anti-fishing finger comprises a first portion extending away from the coin opening and a section portion extending from the first portion downward and at an angle from the first portion.

26. The anti-fishing device of claim 22, wherein the anti-fishing device is made from a single piece of resilient or semi-resilient material.

27. The anti-fishing device of claim 26, wherein the body comprises cut-out tabs located across from the first and second anti-fishing fingers to allow the first and second anti-fishing fingers to be cut out from the single piece of material.
